(19) United States
(12) Patent Application Publication
(10) Pub. No.: US 2012/0239986 A1
(43) Pub. Date: Sep. 20, 2012

(54) SCRIPT EXECUTION WITH FALLBACK

(76) Inventors: Moshe Eran Kraus, Mazkeret Batya (IL); Dror Schwartz, Holon (IL); Ithai Levi, Hod-Hasharon (IL); Amir Kessner, Ramat-Gan (IL)

(21) Appl. No.: 13/047,574

(22) Filed: Mar. 14, 2011

(51) Int. Cl. G06F 11/07

(52) U.S. Cl. 714/49; 714/E11.023

(57) ABSTRACT

A script specifies a script action and an expected reaction in response to the script action. When one of the script actions is executed, a failure is detected indicating that the expected reaction did not occur. In response to the failure, a fallback action is executed.

### BACKGROUND

User actions (such as user selections made in a user interface) during use of a system can be recorded and represented with automation scripts. Such automation scripts can be executed to replay the respective user actions. Executing such automation scripts to replay user actions can be made for various purposes, such as to test a system, or for other purposes.

### BRIEF DESCRIPTION OF THE DRAWINGS

The following figures represent examples or implementations of the invention and not the invention itself.

FIG. 1 is a schematic diagram of an automation system.

FIG. 2 is a flow chart of a process implemented by the system of FIG. 1.

FIG. 3 is a schematic diagram of another automation system.

FIG. 4 is a flow chart of a process implemented by the system of FIG. 3.

### DETAILED DESCRIPTION

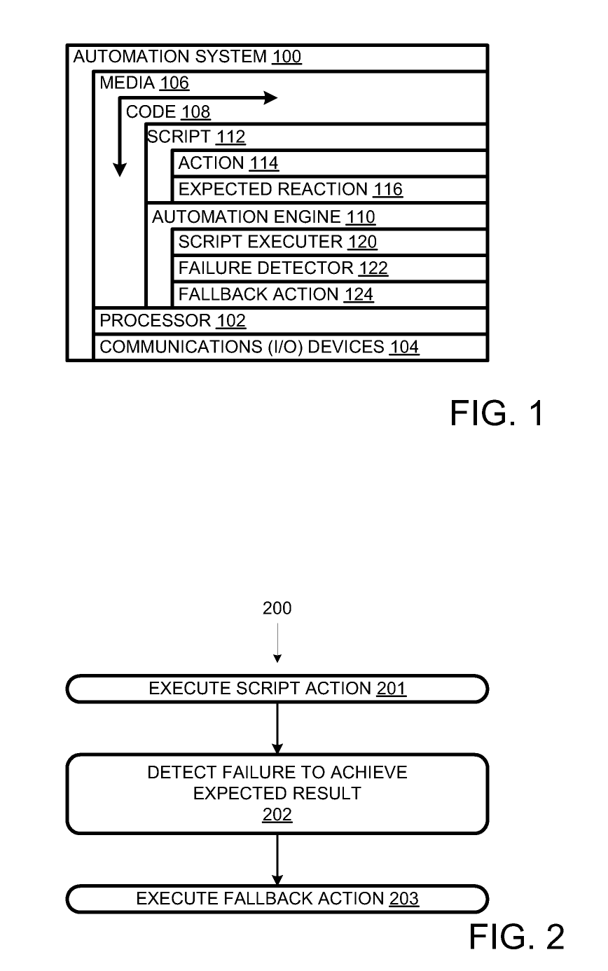

An automation system 100, FIG. 1, executes a fallback action when a script action fails to achieve the expected reaction. As a result, automation system 100: 1) increases the chances for successful script execution, 2) better represents the way a human would interact with an application, and 3) more precisely detects sources of problems (which may be due to website faults, script faults, or automation engine faults).

Automation system 100 includes a processor 102, communications (including input/output) devices 104, and computer-readable storage media 106. Media 106 is encoded with code 108 defining an automation engine 110 and a script 112. Script 112 specifies an action 114 to be performed and a reaction 116 to be expected in response to action 114 being performed. Automation engine includes a script executer 120, a failure detector 122, and fallback action 124.

Automation engine 110 is configured to implement a process 200, flow-charted in FIG. 2. At 201, script executer 120 executes script action 114. At 202, failure detector 122 determines that the expected reaction 116 for action 114 did not occur. At 203, fallback action 124 is executed.

When confronted with a lack of a response or an unexpected response, a human is often able to take corrective action. For example, if a human user clicks on a link and nothing happens, the human may take any one of a number of actions including but not limited to: 1) clicking again in the same position; 2) clicking again in a slightly different position; or 3) typing the link destination into a “go-to” bar. In contrast, an executing script may overlook a failure and continue with succeeding actions, at least until an action cannot be taken (e.g., because the failed action led to the final action being attempted in an incompatible context). At this point, an error condition may be flagged; but the failure that led to the incompatible context is long-since past, making it hard for a trouble-shooting procedure to determine the original cause of the error condition.

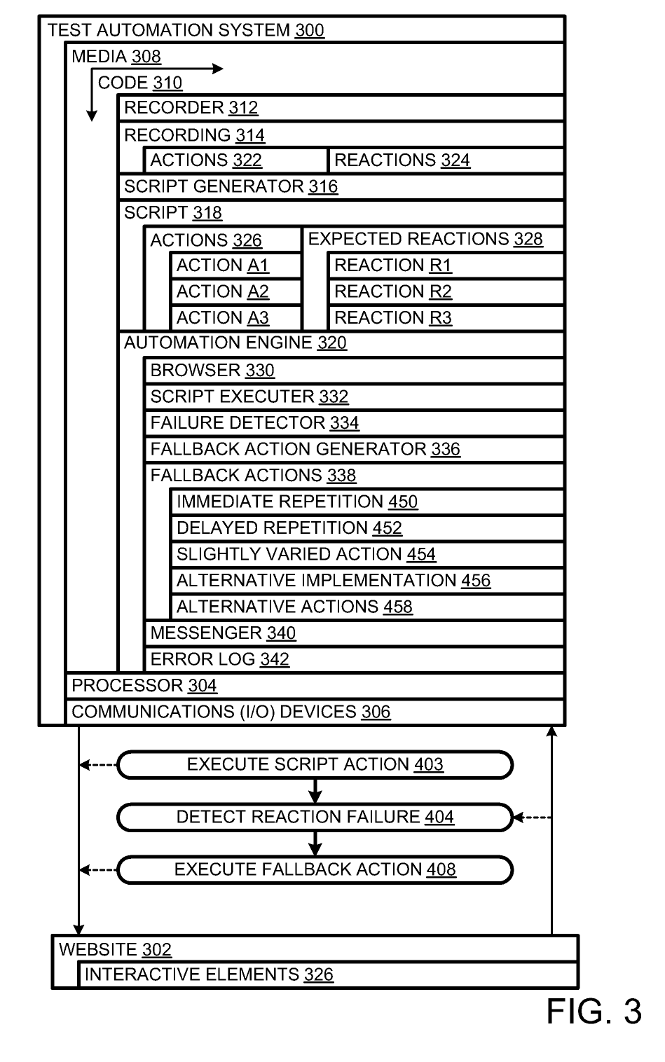

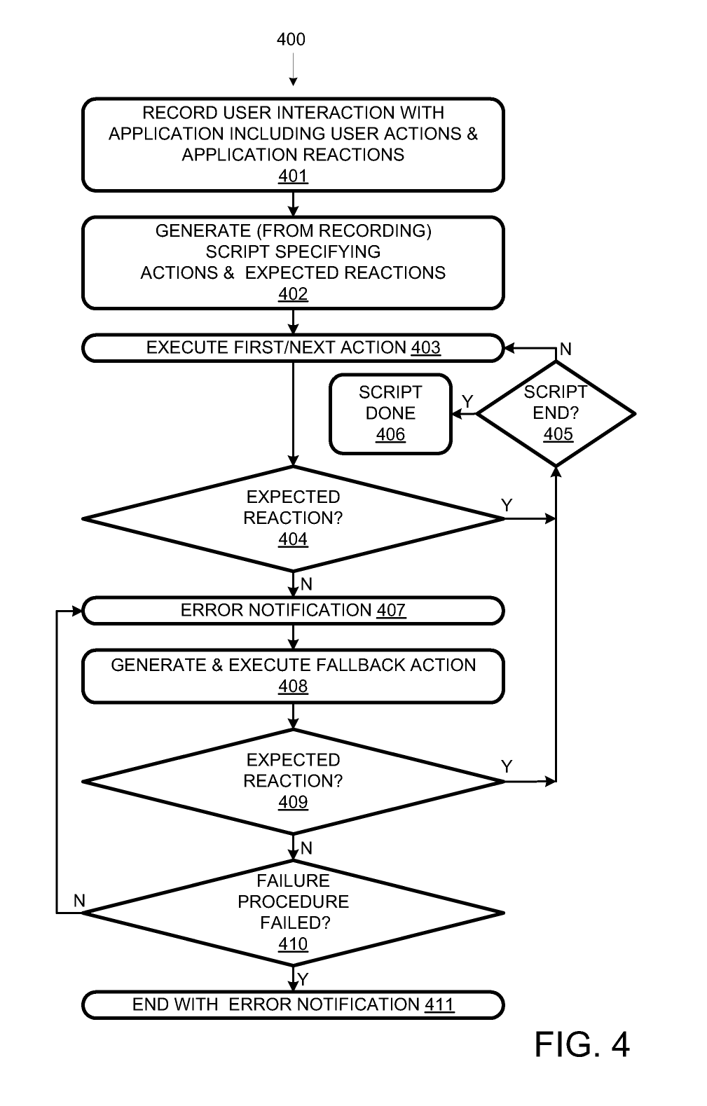

Process 200 detects the failed response before the next action in the script is executed. This makes it easier to determine the original cause of the failure. Furthermore, process 200 acts to ensure the intended context is achieved before continuing with subsequent script actions, thus increasing the likelihood that the script will complete as intended. Also, in detecting failures and executing fallback actions, an automation engine is more closely simulating human user behavior than it would if it executed script actions in sequence without regard to responses. Further features are apparent in the context of system 300, shown in FIG. 3.

Automation system 300 is designed for automated testing of a website 302. To this end, automation system 300 may be based on anything from a single-enclosure computer to a computer with a multitude of geographically distributed positions of placement (POPs). Automation system 300 includes a processor 304, communications (including input/output) devices 306, and computer-readable storage media 308. Media 308 is encoded with code 310 defining or defining functionality for a recorder 312, a recording 314, a script generator 316, a script 318, and an automation engine 320.

User-interaction recorder 312 records: 1) user interactions with website 302 to produce recordings, e.g., recording 314, including both actions 322; and 2) corresponding web-site application reactions 324. Website 302 includes interactive elements 326, e.g., including hyperlinks, buttons, drop-down menus, and sliders. Such interactive elements can be implemented, for example, in the form of web widgets embedded in web pages. A user can act on such elements via a browser and the website typically reacts by changing the view in the browser in some detectable way so that both user actions 322 and website reactions 324 can be recorded.

Script generator 316 is configured to generate scripts from user-interaction recordings. For example, script generator 316 has generated script 318 from recording 314. Script 318 includes (specifies) script actions 326, e.g., script actions A1-A3, and corresponding expected reactions 328, e.g., expected reactions R1-R3. Script actions 326 correspond to recorder user actions 322, while expected reactions 328 correspond to recorded website reactions 324.

Automation engine 320 includes a browser 330, a script executer 332, a failure detector 334, a fallback generator 336, selectable fallback actions 338, a messenger 340, and an error log 342. Browser 330 enables automation engine 320 to interact with website 302; more specifically, script executer 332 uses browser 330 to execute script actions 326 and failure detector 332 uses browser 330 to monitor website reactions to script actions for detecting website reactions to executed script actions. Failure detector 334 compares monitored reactions with expected reactions 328 to determine according to some criteria whether there is a match or a failure. The criterion may involve equivalence, equivalence within some tolerance, or some other range of alternatives.

When failure detector 334 determines an executed script action has failed to achieve the corresponding expected reaction, fallback action generator 336 can select or generate a fallback action 338, e.g., based on the action script, its expected and actual reactions, and presumed cause of failure. There are several types of fallback actions to choose from including an immediate repetition 450, delayed repetition 452, a slightly varied action 454, alternative implementation 456, and an alternative action or action sequence 458. If one fallback action fails, another one can be tried until fallback action generator 336 determines that it is futile to continue trying fallback actions. For each failure of a script action or a fallback action, messenger 340 can generate error messages, which may be logged in error log 342 and/or sent (e.g., via email) to an administrator.

Immediate repetition involves simply re-executing a failed script action upon failure detection. Human's re-execute sometimes when they assume a failure is due to a random glitch that is unlikely to be repeated. Delayed repetition 452 can apply when a failure may be due to some preceding reaction that has failed to complete in time for a script action to be executed; the delay can give the preceding reaction time to complete.

A slightly varied action 454 can involve, for example, clicking at or moving to a slightly different position. For example, a recorded click may have been at the boundary of a button so that the recorded reaction cannot be reproduced reliably. Adjusting the click position so that the clicking is directed at a more central location on the button may be more likely to produce the expected reaction.

An alternative implementation 456 can involve a different procedure for achieving the expected reaction. For example, for a script action of clicking on a button, an alternative implementation might be to navigate to the button using arrow keys and pressing an “enter” key on a keyboard. Alternative actions 458 encompass a wide variety of alternatives, including alternative actions 458 designed to achieve a reaction different from the expected reaction for the failed script action. For example, instead of just repeating the failed script action, the entire script may be restarted. For another example, a debugging tool can be activated to trouble-shoot the failure.

Alternative actions 458 can address the misinterpretation of a recorded user action during script generation. For example, clicking on a checkbox in a graphical user interface may be interpreted as a selection of an associated item, whereas the actual action involved toggling the checkbox off. When script generation applies the wrong interpretation, the wrong reaction may be detected during script execution. When an unexpected reaction is detected, fallback generator 336 can select as an alternative fallback action that is a known alternative interpretation of the recorded user action.

Test automation system 300 implements a process 400, flow-charted in FIG. 4. At 401, recorder 312 records user interactions with website 302 to yield recording 314. At 402, script generator 316 generates script 318 from recording 314. At 403, one of script actions 326 is executed. In a first iteration of 403, script action A1 is executed. At 404, a determination is made whether the reaction of website 302 to the execution of a script action matches (according to some predetermined criterion) the corresponding one of expected reactions 328. In a first iteration of 404, an actual reaction of website 302 to execution of action A1 is compared with expected reaction R1.

If the actual reaction matches the expected reaction, a determination is made at 405 whether or not the script has ended, i.e., if the last script action has been executed. If so, the script is done at 406. A notification to that effect may be logged. In the case that there are additional script actions to execute, process 400 returns to 403. For example, if execution of script action A1 yields an actual reaction matching expected reaction R1, script action A2 is executed at a second iteration of 403.

If at 404, it is determined that an actual reaction to an executed script action does not match the corresponding expected reaction, an error notification is generated and logged at 407. For example, if the actual website reaction to the execution of action A2 does not match expected reaction R2, then process 400 proceeds to 407 and to 408 (in either order).

At 408, fallback action generator 336 generates and script executer executes a fallback action. At 409, failure detector 334 determines whether or not the reaction by website 302 to execution of the fallback action matches its expected reaction. The expected reaction may be the same as the expected reaction for the failed script action or another expected reaction generated by fallback action generator 336 along with the fallback action.

If the actual reaction matches the expected reaction, process 400 returns to 405 to either begin execution of the next script action at 403 or, if there are no more script actions to execute, to end script execution at 406. In the case that the executed action is A2, action A3 is executed in the next iteration of 403. In the case (e.g., in the third iteration) that the previously executed action is A3, process 400 terminates at 406.

If at 409, it is determined that the fallback action has failed, fallback action generator 336 determines whether there are additional (same or different) fallback actions to try. If there are, process 400 returns to 407 for another fallback iteration. If there are no further fallback actions to try, process 400 can terminate at 411 and log and/or send an error notification regarding the termination.

In one example, process 400 is executed once at a single test site. In another example, process 400 is executed repeatedly and in parallel from hundreds or thousands of geographically distributed test sites. One script can act on plural websites, and a given website can be accessed concurrently by different scripts. A script can include one or more actions. The actions of a script may be arranged in a simple linear sequence, or the script may include conditional branches and/or loops. Herein, “generating” encompasses “selecting” as a special case.

Herein, a “system” is a set of interacting non-transitory tangible elements, wherein the elements can be, by way of example and not of limitation, mechanical components, electrical elements, atoms, physical encodings of instructions, and process segments. Herein, “process” refers to a sequence of actions resulting in or involving a physical transformation. “Storage medium” and “storage media” refer to a system including non-transitory tangible material in or on which information is or can be encoded so as to be readable by a computer. “Display medium” and “display media” refer to storage media in which information is encoded in human readable form. “Computer-readable” refers to storage media in which information is encoded in computer-readable form.

Herein, “machine”, “device”, and “computer” refer to hardware or a combination of hardware and software. A “virtual” machine, device or computer is a software analog or representation of a machine, device, or computer, respectively, and not a “real” machine, device, or computer. A “server” is a real (hardware or combination of hardware and software) or virtual computer that provides services to computers. Herein, unless otherwise apparent from context, a functionally defined component (e.g., executer, detector, recorder, generator, messenger, browser) of a computer is a combination of hardware and software executing on that hardware to provide the defined functionality. However, in the context of code encoded on computer-readable storage media, a functionally-defined component can refer to software.

Herein, a computer is a machine having co-located or distributed components including computer-readable storage media, a processor, and one or more communications devices. The media stores or is configured to store code representing data including computer-executable instructions. The processor, which can include one or more central-processing units (CPUs), reads and manipulates data in accordance with the instructions. “Communication(s) device(s)” refers to computer-hosted devices used to transmit and/or receive data. Herein, a “computer network” is a network of communicatively coupled real and, in some cases, virtual nodes, wherein the nodes can be, by way of example and not of limitation, servers, network infrastructure devices, and peripherals. Herein, a “node” encompasses real and virtual devices.

In this specification, related art is discussed for expository purposes. Related art labeled “prior art”, if any, is admitted prior art. Related art not labeled “prior art” is not admitted prior art. In the claims, “said” qualifies elements for which there is explicit antecedent basis in the claims; “the” refers to elements for which there is implicit antecedent basis in the claims; for example, the phrase “the center of said circle” indicates that the claims provide explicit antecedent basis for “circle”, which also provides as implicit antecedent basis for “center” since every circle contains exactly one center. The illustrated and other described examples and implementations, as well as modifications thereto and variations thereupon are within the scope of the following claims.

What is claimed is:

1. A process comprising:
in the course of executing a script specifying an action and a respective expected reaction, executing said script action;
detecting a failure of said script action to achieve said expected reaction; and
in response to the detection, executing a fallback action corresponding to said script action.

2. A process as recited in claim 1 further comprising:
recording a user's interaction with a website to yield a recording representing a user action and a website reaction; and
generating said script from said recording, said expected reaction being based on said website reaction.

3. A process as recited in claim 1 further comprising:
a detection of a failure of said fallback action to achieve a respective expected reaction; and
in response to the detection of the failure of said fallback action, executing a second fallback action.

4. A process as recited in claim 3 wherein the expected reaction for said fallback action is the same as the expected reaction for said script action.

5. A process as recited in claim 3 wherein the expected reaction for said fallback action is different from the expected reaction for said script action.

6. An automation system comprising:
a failure detector configured to detect a failure of an executed script action to achieve an expected reaction, said script action and said expected reaction being specified by a script specifying said action and reaction; and
a script executer for executing said script action and, in the event said script action fails to achieve the expected reaction, a fallback action.

7. An automation system as recited in claim 6 further comprising a fallback action generator for generating said fallback action based on said script action.

8. An automation system as recited in claim 6 wherein said failure detector is further configured to detect a failure of said fallback action to achieve said expected reaction.

9. An automation system as recited in claim 8 further comprising a messenger for generating and logging notices regarding said failures.

10. An automation system as recited in claim 6 further comprising:
a recorder configured to generate a recording of user interactions with a website, said recording representing user actions and website reactions to those user actions; and
a script generator for generating said script from said recording so that said script specifies said script action and said expected reaction, said expected reaction being based on said website reactions.

11. A system comprising computer-readable storage media encoded with code configured to, when executed by a processor,
execute a script specifying a script action and an expected reaction to said action,
in the course of executing a script, executing a script action; and
in the event the respective expected reaction does not occur when said script action is executed, executing a fallback action designed to achieve said expected result.

12. A system as recited in claim 11 further comprising said processor.

13. A system as recited in claim 11 wherein said code is further configured to, when executed by said processor:
detect a failure of said fallback action to achieve said expected reaction; and
in response to a detection of said failure of said fallback action, generate and execute a second fallback action.

14. A system as recited in claim 11 wherein said code is further configured to, when executed by said processor:
record user interactions with a website so as to generate a recording representing a user action and a website reaction to that action; and
generate said script from said recording so that said expected reaction is based on said website reaction.

15. A system as recited in claim 11 wherein said code is further configured to, when executed by said processor, generate and log an error notification in the event that the respective expected reaction does not occur when said script action is executed.
